(19) United States
(12) Patent Application Publication
(10) Pub. No.: US 2024/0397583 A1
(43) Pub. Date: Nov. 28, 2024

(54) METHOD FOR APPLYING AN ELECTRIC HEATING FOIL, AS WELL AS A BUILDING PROVIDED WITH THE HEATING FOIL

(71) Applicant: CALOR INVESTMENTS B.V., Valkenswaard (NL)

(72) Inventors: Marcus Gerardus Antonius VAN KRUIJSDIJK, Valkenswaard (NL); Nick VAN KRUIJSDIJK, Valkenswaard (NL); Raymond Edward Mario VAN DER WEIJDEN, Valkenswaard (NL)

(21) Appl. No.: 18/699,325

(22) PCT Filed: Oct. 7, 2022
(86) PCT No.: PCT/NL2022/050565

§ 371 Date: Apr. 8, 2024

(30) Foreign Application Priority Data
Oct. 8, 2021 (NL) 2029372
Jun. 28, 2022 (NL) 2032299

(51) Int. Cl. H05B 3/28

(52) U.S. Cl. CPC H05B 3/28; H05B 2203/011; H05B 2203/016; H05B 2203/026; H05B 2203/032

(57) ABSTRACT

In a method for applying a heating foil, a heating foil 11 is over the entire underside attached to a hard surface 3 and an upper layer 5 is attached to the heating foil 11 over the entire top side of the heating foil 11. By fixing the heating foil 11 on a hard surface 3 and fixing the top layer 5 directly on the heating foil 11, a thin top layer will suffice, so that the infrared radiation is absorbed less and the space above the floor 1 is therefore better heated. The heating foil 11 is glued directly onto the hard substrate 3 by means of a first viscous adhesive layer 7 and the top layer 5 is glued directly onto the top side 11b of the heating foil 11 by means of a second viscous adhesive layer 9. The adhesive layers 7 and 9 are of the same viscous material Semco Liquid Membrane™ which is an elastomeric liquid suspended in a copolymer adhesive.

### TECHNICAL FIELD OF THE INVENTION

The invention relates to a method of applying an electric heating foil, comprising:
applying the electric heating foil to a substrate, which heating foil is provided with a bottom side which faces the substrate, as well as a top side which radiates heat, and
applying a top layer to the top side of the heating foil.

A heating foil is generally known in the form of resistance elements which become hot when they conduct current and in the form of radiant elements which radiate infrared radiation when they conduct current.

### BACKGROUND OF THE INVENTION

Such a method is known. In the known method, a soft layer is first applied to the substrate, for instance insulating material, then the heating foil is applied to the soft layer, and then again a soft layer, for instance vapor foil, is applied to the heating foil.

The heating foil is, as it were, suspended in the floor, with many air chambers present in the soft layer.

Due to the soft layers below and above the heating foil, the heat emission is less effective because heat emission to the air is less efficient. In addition, this method limits the possibilities to which the top layer can be applied.

### SUMMARY OF THE INVENTION

An object of the invention is to provide a method for arranging electric heating foil of the type described in the preamble in such a way that a more efficient heating (and installation) is thereby realized. To this end, the method according to the invention is characterized in that:
the heating foil is attached to a hard surface over the entire underside by means of a first viscous adhesive layer, and
the top layer is attached directly to the heating foil over the entire top side of the heating foil by means of a second viscous adhesive layer,
wherein the same viscous material is used for the first and second adhesive layers.

By a hard surface is meant that the surface is preferably not made of a compressible or resilient material. The top layer can also be made of a hard material, for example ceramic or concrete tiles. The heating foil can be used in a floor as well as in a wall or in another part.

By attaching the heating foil to a hard surface and attaching the top layer directly to the heating foil, a thin layer on the heating foil will suffice, so that the radiation is less absorbed by the layer on the heating foil and the space above the floor is therefore better heated.

It has been found that an elastomeric liquid suspended in a copolymer adhesive has excellent properties for use as a viscous material. The material Semco Liquid Membrane™ has proven to be ideally suited to serve as the viscous material.

Before the viscous adhesive layer is applied, a primer can first be applied to the substrate, to the top layer and/or to the heating foil to allow the adhesive layer to adhere better. This is not necessary when using Semco Liquid Membrane™ as an adhesive layer. It is therefore sufficient to have only one layer between the heating foil and the substrate and only one layer between the top layer and the heating foil. In this case, the adhesive layer can first be applied directly to the substrate and top layer and to the heating foil and then the parts can be applied to each other, whereby the adhesive layers form one layer between the parts.

The advantages obtained by attaching the heating foil directly to a substrate and attaching the top layer directly to the heating foil are even more present when infrared heating foil is used than in heating foil that radiate heat due to heat development as a result of current through a resistor. Therefore, the method according to the invention gives the most advantages when using electric infrared heating foil as heating foil.

The invention also relates to a building provided with an electric heating foil, comprising:
a substrate,
an electric heating foil provided with a bottom side with which the heating foil faces the substrate and a top side which radiates heat, and
a top layer which is present over the entire top side on the heating foil.

With regard to the building, the invention is characterized in that:
the substrate is hard,
between the substrate and the entire underside of the heating foil there is only one layer, which layer is formed by a first adhesive layer with which the heating foil is attached directly to the substrate, and
between the entire top side of the heating foil and the top layer there is only one layer, which layer is formed by a second adhesive layer with which the top layer is attached directly to the heating foil,
wherein the first and second adhesive layer are of the same viscous material.

The viscous material is preferably an elastomeric liquid suspended in a copolymer adhesive. Preferably this is Semco Liquid Membrane™.

Also in a building, the advantages are greatest if an infrared heating foil is used as heating foil, so that the building has the most advantages when electric infrared heating foil is used as heating foil.

An embodiment of the building according to the invention is characterized in that the electric heating foil:
comprises a number of parallel, spaced apart electrically conductive heating tracks, each provided with two ends, as well as
two connection tracks, one of which is connected to one of the ends of the heating tracks and the other being connected to the other ends of the heating tracks, which connection tracks each have a connection end, and
two protective foils between which the heating tracks and the connection tracks are present and which are attached to each other and to the tracks,
wherein the connection ends of the connection tracks are free of the protective foil on at least one side, and
wherein power supply tracks for connection to an electrical power supply are connected to these connection ends via a connector, which connector comprises two strips which are connected to each other via a plastically bendable bridge piece, which strips are provided with protrusions on one side, said sides provided with protrusions, are bent towards each other and the connecting end and one end of one of the power supply tracks being between said sides and being clamped together, wherein the projections on one of the sides being adjacent to the projections on the other side.

This connector is simple and therefore cheap and requires little installation height, so that the floor does not have to be made thicker than without the presence of this connector.

### BRIEF DESCRIPTION OF THE DRAWINGS

The invention will be further elucidated below on the basis of drawings. These drawings show an embodiment of the building according to the present invention. In the drawings:

FIG. 1 shows a vertical section of a floor of the building according to the invention;

FIG. 2 shows the heating foil present in the floor;

FIG. 3 shows one of the connectors before it has been applied;

FIG. 4 shows the connector with clamping parts bent towards each other in top view;

FIG. 5 is a front view of the connector with clamping parts bent towards each other; and

FIG. 6 shows the connector with clamping parts bent towards each other in side view.

### DETAILED DESCRIPTION OF THE DRAWINGS

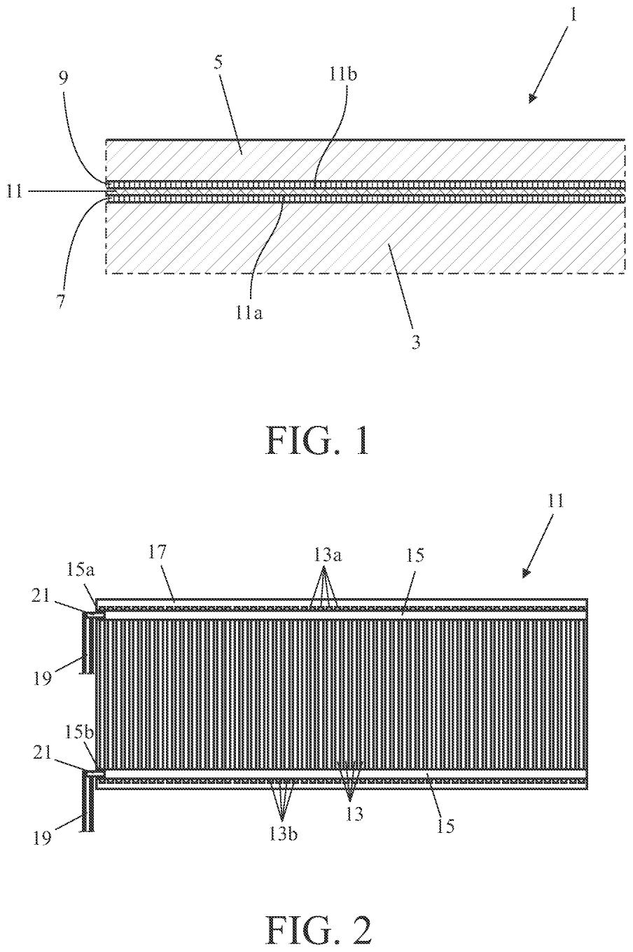

FIG. 1 shows a floor of the building according to the invention in vertical section, wherein the layered construction is clearly visible. The floor 1 consists of a substrate 3 on which an upper layer 5 to be walked on is attached. In this embodiment the hard substrate is formed by a concrete floor and the top layer 5 in this embodiment is formed by ceramic tiles. Between the hard substrate 3 and the top layer 5 there is an electric underfloor heating foil 11, which in this embodiment is formed by an infrared heating foil. This heating foil 11 is attached to the substrate with the underside 11a via a first adhesive layer 7 and the top layer 5 is attached to the upper side 11b of the heating foil 11 via a second adhesive layer 9. The first adhesive layer 7 and the second adhesive layer 9 are of the same viscous material, Semco Liquid Membrane™, which is an elastomeric liquid suspended in a copolymer adhesive.

FIG. 2 shows the infrared heating foil 11 of the floor. The electric heating foil 11 has a number of parallel, spaced apart electrically conductive heating tracks 13, which are connected by ends 13a, 13b to two connection tracks 15. The connection tracks 15 are provided with connection ends 15a and 15b. The heating tracks 13 and the connecting tracks 15 are present between two protective foils 17. These protective foils 17 are attached to each other and to the tracks.

The connecting ends 15a, 15b of the connecting tracks 15 are free from the protective foil 17 on at least one side. Power supply tracks 19 are connected to the connecting ends 15a, 15b via a connector 21 for connecting the heating foil 11 to an electrical supply.

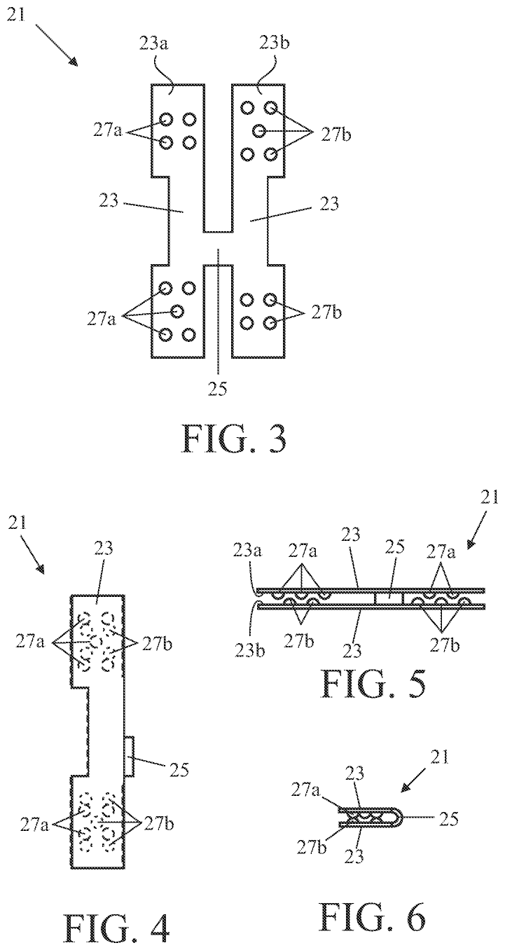

FIG. 3 shows one of the connectors 21 before it has been used. The connector 21 has two strips 23 which are connected to each other via a plastically bendable bridge piece 25. The strips and the bridge piece are made of one whole and of electrically conductive material. On one side 23a, 23b the strips 23 are provided with projections 27a and 27b.

In FIGS. 4, 5 and 6 this connector is shown in applied form. The sides 23a and 23b provided with projections are herein bent towards each other, wherein the projections 27b on one of the sides 23b are present next to the projections 27a on the other side 23a. During use in the situation shown in FIG. 2, the ends of the power supply tracks and the connecting tracks are located between the strips 23. At least one side of these tracks is not insulated so that the projections 27a and/or the projections 27b are in electrical contact with the tracks and connect the tracks electrically.

Although the present invention is elucidated above on the basis of the given drawings, it should be noted that this invention is not limited whatsoever to the embodiments shown in the drawings. The invention also extends to all embodiments deviating from the embodiments shown in the drawings within the scope of the invention defined by the appended claims.

1. Method of applying an electric heating foil, comprising:
applying the electric heating foil (11) to a substrate (3), which heating foil (11) is provided with a bottom side (11a) which faces the substrate (3), as well as a top side (11b) which radiates heat, and
applying a top layer (5) to the top side (11b) of the heating foil (11),
characterized in that:
the heating foil (11) is attached to a hard surface (3) over the entire underside (11a) by means of a first viscous adhesive layer (7), and
the top layer (5) is attached directly to the heating foil (11) over the entire top side (11b) of the heating foil (11) by means of a second viscous adhesive layer (7),
wherein the same viscous material is used for the first and second adhesive layers (7, 9).

2. Method according to claim 1, characterized in that the viscous material used is an elastomeric liquid suspended in a copolymer adhesive.

3. Method according to claim 2, characterized in that Semco Liquid Membrane™ is used as the viscous material.

4. Method according to claim 1, characterized in that an electric infrared heating foil is used as the electric heating foil (11).

5. Building provided with an electric heating foil, comprising:
a substrate (3),
an electric heating foil (11) provided with a bottom side (11a) with which the heating foil (11) faces the substrate (3) and a top side (11b) which radiates heat, and
a top layer (5) which is present over the entire top side (11b) on the heating foil (11),
characterized in that:
the substrate (3) is hard,
between the substrate (3) and the entire underside (11a) of the heating foil (11) there is only one layer, which layer is formed by a first adhesive layer (7) with which the heating foil (11) is attached directly to the substrate (3), and
between the entire top side (11b) of the heating foil (11) and the top layer (5) there is only one layer, which layer is formed by a second adhesive layer (9) with which the top layer (5) is attached directly to the heating foil (11),
wherein the first and second adhesive layer (7, 9) are of the same viscous material.

6. Building according to claim 5, characterized in that the viscous material is an elastomeric liquid suspended in a copolymer glue.

7. Building according to claim 6, characterized in that the viscous material is Semco Liquid Membrane™.

8. Building according to claim 5, characterized in that the electric heating foil (11) is an electric infrared heating foil.

9. Building according to claim 5, characterized in that the electric heating foil (11):
comprises a number of parallel, spaced apart electrically conductive heating tracks (13), each provided with two ends (13a, 13b), as well as
two connection tracks (15), one of which is connected to one of the ends (13a) of the heating tracks (13) and the other being connected to the other ends (13b) of the heating tracks (13), which connection tracks (15) each have a connection end (15a, 15b), and
two protective foils (17) between which the heating tracks (13) and the connection tracks (15) are present and which are attached to each other and to the tracks,
wherein the connection ends (15a, 15b) of the connection tracks (15) are free of the protective foil (17) on at least one side, and
wherein power supply tracks (19) for connection to an electrical power supply are connected to these connection ends (15a, 15b) via a connector (21), which connector (21) comprises two strips (23) which are connected to each other via a plastically bendable bridge piece (25), which strips (23) are provided with protrusions (27a, 27b) on one side (23a, 23b), said sides (23a, 23b) provided with protrusions, are bent towards each other and the connecting end (15a, 15b) and one end of one of the power supply tracks (19) being between said sides (23a, 23b) and being clamped together, wherein the projections (27b) on one of the sides (23b) being adjacent to the projections (27a) on the other side (23a).
